(19) United States
(12) Patent Application Publication
(10) Pub. No.: US 2007/0169351 A1
(43) Pub. Date: Jul. 26, 2007

(54) Folding tool with lockback mechanism

(75) Inventor: Kenneth Steigerwalt, Orangeville, PA (US)

Correspondence Address: IPSOLON LLP, 111 SW COLUMBIA, SUITE 710, PORTLAND, OR, 97201, US

(73) Assignee: Mentor Group LLC

(21) Appl. No.: 11/340,332

(22) Filed: Jan. 25, 2006

(51) Int. Cl. B26B 3/06

(52) U.S. Cl. 30/155

(57) ABSTRACT

A hand tool such as a folding knife incorporates a lockback mechanism that is sprung with spring arms extending parallel to the knife body. The spring arms apply biasing force to the lockback mechanism.

### FIELD OF THE INVENTION

This invention relates to knives and other tools that incorporate folding implements, and more specifically to a blade or implement locking mechanism for use in such tools that facilitates secure locking of the implement in the open or extended position.

### BACKGROUND

Folding knives have one or more blades that pivot on a shaft attached to the handle so that in a stowed position the blade is received with the cutting portion of the blade retained safely in the interior of the handle. In an extended position the blade is extended away from the handle, ready for use. To increase the safety of folding knives, many incorporate locking mechanisms of one type or another. When the knife blade pivots into the open position, its pivotal movement is stopped with a blocking mechanism such as a transverse blade stop pin housed in the handle. Often a locking mechanism is included that prevents the blade from unintentionally pivoting back from the open into the closed position.

There are many types of locking mechanisms. One common type is a “liner lock.” This kind of mechanism relies upon a resilient lever formed as part of a handle liner. When the blade is pivoted to the open or extended position, the resilient lever engages a cooperatively formed shoulder on the blade and thereby locks the blade in the open position.

Another typical locking mechanism is a cross-bolt mechanism such as that described in U.S. Patent No.5,822,866. As detailed in the 866patent, which describes an automatic opening knife, the cross-bolt mechanism includes a locking body that has a cylindrically tapered side wall portion. When the blade is extended to the open position, the tapered side wall portion of the locking body is urged by a compression spring into a locking position in which the locking body wedges between an engagement surface on the blade and a bore in the handle to lock the blade in the open position.

Yet another common type of locking mechanism is called a “lockback” mechanism. While there are variations in the structure for a lock back, in most lock back mechanisms a latch bar held between the handles at the upward side or spine thereof pivots on a pivot pin extending through the latch bar and having opposite ends connected to the handle halves. When the blade or other implement is in the extended position, a spring mounted in the rearward portion of the handle (between the handle halves) applies upwardly directed pressure on the latch bar rearward of the pivot, urging the forward end of the latch bar—that is, the end of the latch bar on the opposite side of the pivot pin from the spring—into a locking engagement with the blade. The forward end of the latch pin typically includes a tooth that engages a notch in the blade tang. The blade is unlocked by pushing downwardly on the rearward end of the latch pin at a notch in the handles—against the spring force, to cause the tooth on the forward end of the latch bar to pivot upwardly and disengage the blade tang.

So-called “lockback” mechanisms are used in many knives. However, the spring mechanisms may be subject to breaking or being damaged over time. For example, many lockback knives use coil springs to apply pressure to the lockback lever. These springs are subject to failure fairly regularly. As such there is a need therefore for improved locking mechanisms for folding hand tools, and in particular improved lock back mechanisms.

The present invention relates to a hand tool—typically embodied as a knife—that incorporates an improved lockback type locking mechanism for securely locking the implement such as a blade in the open position, and for releasing the lock to allow the implement to be folded back into the closed position.

### BRIEF DESCRIPTION OF THE DRAWINGS

The invention will be better understood and its numerous objects and advantages will be apparent by reference to the following detailed description of the invention when taken in conjunction with the following drawings.

FIG. 1 is a perspective view of a knife that is exemplary of the type of hand tool that incorporates a lockback mechanism according to the present invention. In FIG. 1 the knife blade is in the open or extended position.

FIG. 2 is a perspective exploded view of the knife shown in FIG. 1 illustrating the component parts.

FIG. 3 is a side elevation view illustrating the knife shown in FIG. 1.

FIG. 4 is a side elevation view identical to the view of FIG. 3, except the handle and the liner on the near side of the knife handle have been removed to expose the interior of the knife.

FIG. 5 is a side elevation view of the knife shown in FIG. 4 illustrating the release operation of the lockback mechanism, which allows the blade to be rotated toward the closed position.

FIG. 6 is another side elevation view similar to FIG. 5 but showing the blade further rotated toward the closed position.

FIG. 7 is yet another side elevation view similar to FIGS. 5 and 6, showing the blade in the fully closed position.

FIG. 8. is a front elevation view of the knife shown in FIG. 1.

FIG. 9 is a perspective view of an alternative embodiment of a knife that that incorporates a lockback mechanism according to the present invention.

FIG. 10 is a perspective exploded view of the knife shown in FIG. 9.

### DETAILED DESCRIPTION OF THE PREFERRED EMBODIMENTS

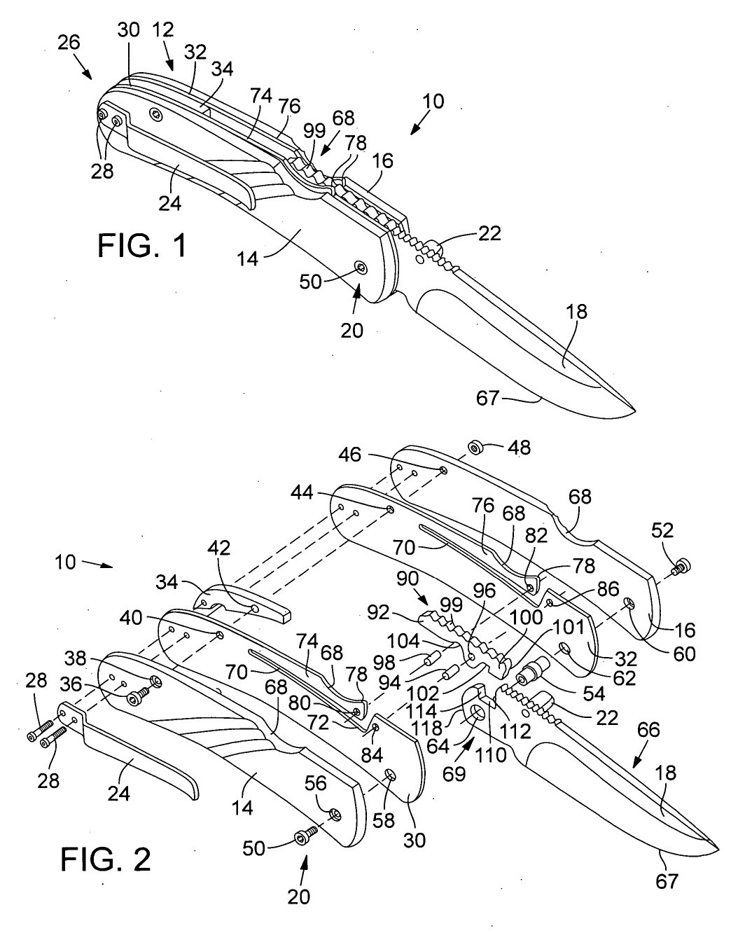

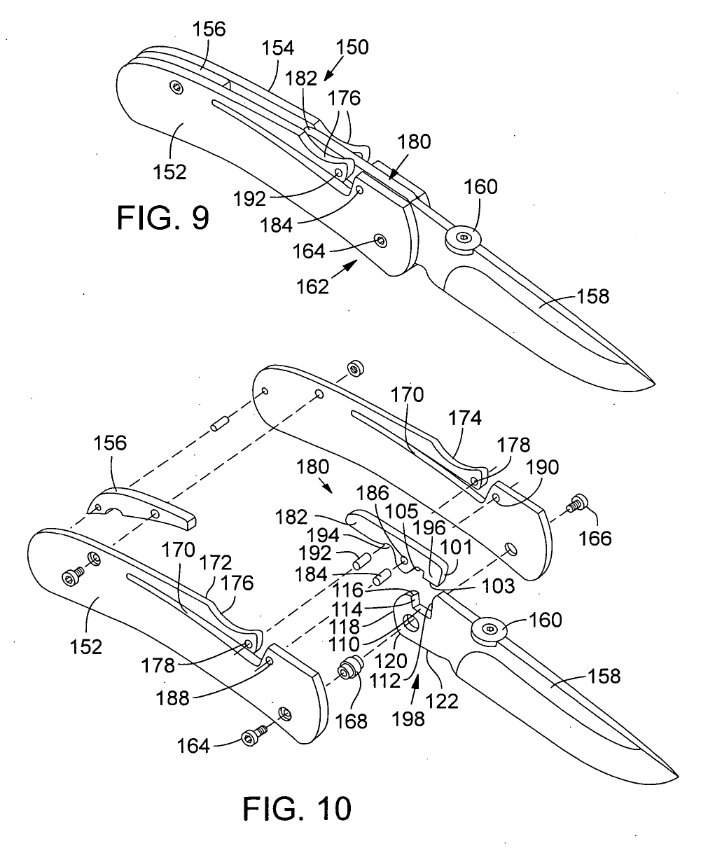

A preferred embodiment of a hand tool 10 incorporating a locking mechanism in accordance with the illustrated invention is shown in FIGS. 1 through 8. An alternative embodiment is shown in FIGS. 9 and 10. Although the invention is described with respect to its embodiment in a particular type of tool—a knife—it will be appreciated that references to a knife are for illustrative purposes to describe the invention. Those of ordinary skill in the art will appreciate that the invention described herein is not limited to knives, but instead extends to any hand tool having the features described.

With particular reference now to FIGS. 1 and 2, knife 10 includes a handle 12 comprising a first handle half 14 and a second handle half 16. The knife 10 shown in the figures is a traditional folding knife that has a single cutting blade 18 pivotally connected between the handle halves at a pivot shaft, shown generally at 20. A thumb lug 22 is attached to the blade 18. The thumb lug assists the user with opening the blade. An optional retaining clip 24 is attached to the butt end 26 of handle 12 with a pair of screws 28, which as shown in FIG. 2 extend completely through the first handle half and extend into the second handle half. A first liner 30 is positioned immediately adjacent first handle half 14 and a second liner 32 is positioned immediately adjacent second handle half 16. As may be seen in FIG. 1, the paired handled halves and associated liners are held together in the assembled knife. Specifically, the combined first handle half 14 and first liner 30 are held in a parallel orientation to the combined second handle half 16 and second liner 32 in a spaced apart relationship by a spacer 34 to define a blade-receiving groove between the handle halves.

Knife 10 is held together with screws spaced around the handle, and the components of the pivot shaft. Specifically, a rear screw 36 extends through aligned bores 38, 40, 42, 44, 46 in first handle half 14, first liner 30, spacer 34, second liner 32 and second handle half 14, respectively and threads into a nut 48. The pivot shaft 20 includes opposed screws 50 and 52 that extend through aligned bores in the handle halves (56 and 60), first and second liners (58 and 62) and thread into opposite ends of a threaded bushing 54 that is received in the pivot bore 64 of blade 18. Threaded bushing 54 is larger in diameter in the center portion where the bushing fits in pivot bore 64; the opposite ends of bushing 54 on either side of the larger diameter portion extend through the respective liners and into the respective handle halves.

Both handle halves 14 and 16, and first and second liners 30 and 32 have a thumb notch 68 formed in the upper edge. When the knife is assembled, the thumb notches on each part align as shown in FIG. 1.

Blade 18 is defined by a working portion 66 and a tang portion 69. The working portion is generally the forward portion of the blade that is exposed when the blade is in the open position and includes the sharpened cutting edge 67. The tang portion 69 of the blade is the rearward portion that is retained between the handle halves. Relative directional terms used herein are based upon the “rearward” or butt end 26 of handle 12, and the opposite or forward end. “Upper” or “top” refers to the direction toward the top of handle 12 that includes the thumb notch 68, and “lower” or “bottom” refers to the direction toward opposite side of handle 12.

With specific reference to FIG. 2, each of the liners 30 and 32 is identical and includes an elongate slot 70 cut into the liner near the upper edge of the liner. Slots 70 begin near the rear portion of the liners, extend in the forward direction and turn upwardly at a corner 72 and through the upper edge of the liners so that the slots are generally L-shaped in overall configuration. The liners are preferably fabricated from a metal that is resilient, such as titanium or tempered steel. Because the liners are resilient, slots 70 define spring arms 74 and 76 (spring arm 74 is the spring arm in first liner 30, and spring arm 76 is the spring arm defined in second liner 32). When the slots 70 are cut into the liners, the forward ends 78 of the spring arms are deflected upwardly slightly so that the forward ends of the spring arms in a normal resting position are separated from the main portion of the liners. This structure is utilized so that the spring arms constantly apply biasing force against the lockback mechanisms, as detailed below. The forward ends of the spring arms may be moved downwardly, toward the blade-receiving groove between the handles, but against the spring force of the arms, which is directed upwardly. A bore 80 is formed in the forward end 78 of spring arm 74, and a bore 82 is formed in the forward end 78 of spring arm 76. Bores 80 and 82 align in the assembled knife. Similarly, aligned bores 84 and 86 are formed in liners 30 and 32, respectively, immediately forward of the position where the spring arms 74 and 76 terminate.

The lockback mechanism 90 is defined by a lockback lever 92 that is pivotally mounted between liners 30 and 32 with a pivot pin 94 that extends through a pivot bore 96 in the lever and has its opposite ends received in bores 84 and 86 in liners 30 and 32, respectively. A spring pin 98 has its opposite ends received in bores 80 and 82 and spans between the two liners. The upper edge 98 of lockback lever 92 is knurled. The lower edge of lever 92 includes a generally downwardly extending tooth 100 at the forward end of the lever, a notch 102 immediately rearward of tooth 100, and a saddle 104 rearward of pivot pin 94. The forward face of tooth 100 is identified with reference number 101, and the lowermost face is identified with 103 (see e.g., FIG. 4). The rearward face of the tooth is identified with number 105.

Spring arms 74 and 76 are compressed during assembly of the knife when spring pin 98 is inserted into the associated bores 78 in spring arms 74 and 76. Spring pin 98 rides in saddle 104 such that in the assembled knife the pin rests against the lower side of the lever in the saddle. Because spring pin 98 is located to the rear of pivot pin 96, and because the spring arms are compressed when assembled, the spring pin 98 constantly exerts biasing force on the lever 92.

Thus, when the knife is assembled the spring arms are preloaded with spring force by virtue of the spring pin 98. The result is that the spring arms normally apply upwardly directed pressure against lever 92, rearward of pivot pin 94, through spring pin 98. Because spring pin 98 is located rearward of pivot pin 94, the front end of the lever is normally urged downwardly.

The tang portion 69 of blade 18 includes a notch 110 that is defined by a generally upright forward wall portion 112 and a generally upright rearward wall portion 114. Notch 110 is cooperatively shaped to receive tooth 100. Notch 110 is located generally above pivot bore 64. Rearward of wall portion 114 on tang 69 is a shoulder 116 and a generally accurate rear surface 118 which terminates at a shoulder 120. Forward of shoulder 120 is a flattened surface 122 that serves as a blade retaining surface.

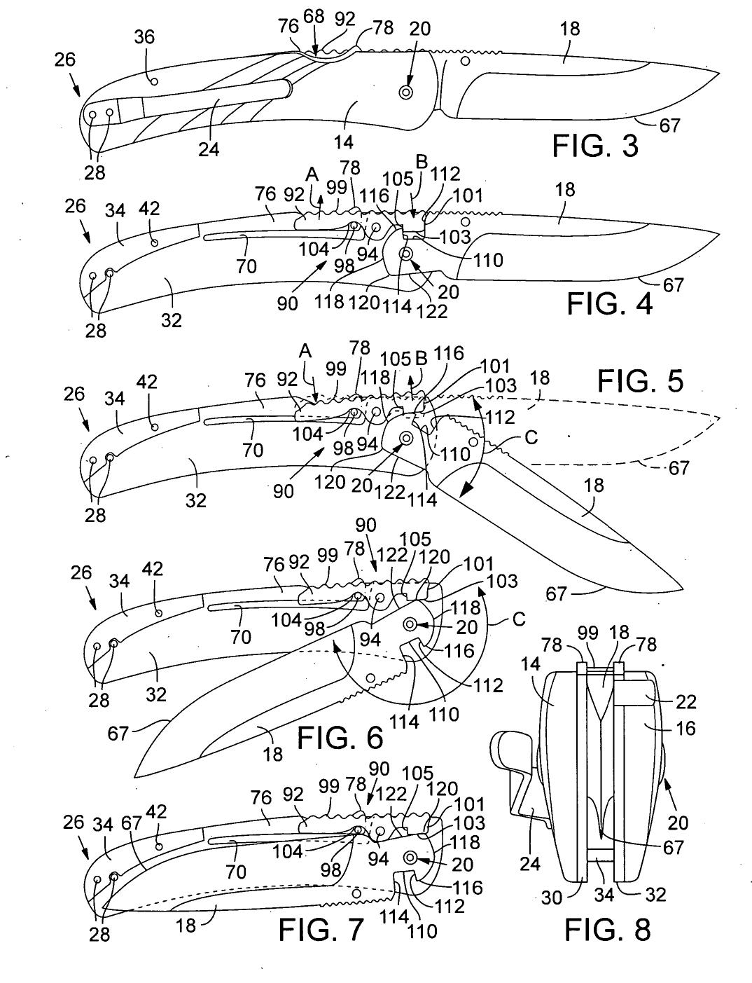

Turning now to FIG. 3, it may be seen as noted earlier that in a resting position the forward end 78 of spring arm 74 (and also the forward end 78 of spring arm 76) is normally deflected upwardly relative to the upper edge of handle half 14 at thumb notch 68. Thus, when the knife is assembled, and particularly when the lockback mechanism 90 is assembled between liners 30 and 32, spring pin 98 exerts pressure against the lower side of lever 92 through where the pin resides in saddle 104.

In FIG. 4 the near side handle half 14 and first liner 30 have been removed to illustrate the locking action of lockback mechanism 90. Reiterating what was said above, at all times spring arms 74 and 76 exert force against lever 92 of lockback mechanism 90. This constant force is applied to lever 92 at a point rearward of pivot pin 96 by virtue of spring pin 98. In FIG. 4 this constant pressure is illustrated with arrow A. It will be appreciated that forward of pivot pin 96 the force on lever 92 is directed downwardly, as shown with arrow B. With blade 18 in the fully open position, tooth 100 is urged downwardly (arrow B) and the tooth engages notch 110 in tang 69 of blade 18. This is the locked open position where the tooth 100 engages the notch 110 and locks the blade open. The forward face 101 of lever 92 abuts the forward wall portion 112 of notch 110 in the locked position and as such, the lockback lever 92 not only acts as a lock, but thus also acts as a blade stop, stopping rotation of blade 18 in the opening direction. In the locked position the rearward face 105 of tooth 100 abuts the rearward upright wall portion 114 of notch 110. Because of the constant pressure applied to lever 92 by spring arms 74 and 76, tooth 100 is maintained in this locking position and the blade is secure until the lock is intentionally released.

Release of the locked position is shown in FIG. 5. In this figure, downwardly directed pressure has been applied to lever 92 rearward of pivot pin 96, in the direction of arrow A. This is the pressure that would be applied by a user pressing on lever 92 in thumb notch 68. Because lever 92 is urged upwardly by the spring arms 74 and 76 as detailed above, the amount of downward pressure applied against the lever must be sufficient to overcome the normal upward biasing force. Once the normal force is overcome, the rear end of lever 92 pivots downwardly (arrow A) and the forward end pivots upwardly (arrow B). As this occurs, tooth 100 disengages from notch 110, releasing blade 18 so that it may be rotated (arrow C). As blade 18 is rotated from open toward closed, the lower face 103 of tooth 100 is pressed against and rides over shoulder 116. At all times there is pressure exerted on the tang of the blade through tooth 100 by virtue of the normal biasing force applied to lever 92. As the blade continues in its rotation, tooth 100 rides over the accurate rear face 118 of tang 69. The pressure applied against the blade by lever 100 tends to cause the blade to resist rotation, thereby controlling the rotation of the blade into the closed position. Once the tooth 100 rides over shoulder 120 (FIG. 6), the blade is pushed into the closed position by pressure applied against flattened portion 122 of tang 69 by tooth 100. This draws the blade into the closed position shown in FIG. 7. In this position the lower face 110 of tooth 100 is pressed against flattened portion 122 of blade 18, thereby securely retaining the blade closed under spring pressure applied to the blade by the tooth.

Blade 18 is rotated from the closed position to the open position by grasping the exposed portion of the blade and rotating it. As the blade rotates, tooth 100 of lever 92 rides over tang 69 and the lever is thus deflected against the biasing force applied by spring arms 74 and 76 against the lever through spring pin 98. When the blade 18 is rotated to the fully open position, tooth 100 is urged into notch 110, again under the force applied to the lever 92 by the spring arms. When tooth 100 is received into notch 110, the blade 18 is locked in the open position and may not be rotated in either direction.

It will be appreciated that it is possible to incorporate a lockback mechanism according to the present invention in a knife that omits the liners 30 and 32, by forming the spring arms into the handles of the knife. An alternative showing this embodiment is shown in FIGS. 9 and 10. There, knife 150 includes a first handle half 152 and second handle half 154 held in a spaced apart orientation by a spacer 156 located at the butt end of the knife between the handle halves, and by blade 158 at the forward end of the knife. Blade 158 includes a thumb lug 160, and the blade is pivotally connected to the handle halves with a pivot shaft 162 with opposed screws 164 and 166 that thread into a threaded bushing 168 as described above with respect to the knife of FIGS. 1 through 8.

The handles halves of the knife shown in FIGS. 9 and 10 are fabricated from a resilient material because the spring arms that act on the lockback mechanism are defined by the handle material. Each handle half 152 and 154 has an elongate slot 170 cut into the handle, in the same manner as slots 70 described above are cut into liners 30 and 32, to define spring arms 172 and 174. The upper edges of the spring arms include a thumb notch 176 and bores 178 in the forward ends of the spring arms. The spring arms are deflected upwardly when cut so that as detailed above, the spring arms always apply pressure against the lockback mechanism in the assembled knife.

Lockback mechanism 180 is identical to mechanism 90 described above, and includes a lockback lever 182 pivotally connected between handle halves 152 and 154 with a pivot pin 184 that extends through a bore 186 in the lever and has opposite ends received in bores 188 and 190 in handle halves 152 and 154 respectively. A spring pin 192 has its opposite ends received in bores 178 and rides in saddle 194 in the lower portion of lever 182. Lever 182 is constructed in the same manner as lever 92, and thus includes a locking tooth 196. The other structural features of tooth 196 are labeled with the same reference numbers as noted above. Tang 198 of blade 158 is also constructed identically to tang 69 of blade 18 in FIGS. 1 through 8 and is labeled with the same reference numbers.

It will be appreciated that the lockback mechanism 180 of FIGS. 9 and 10 operates in an identical manner to the lockback mechanism 90 described above. It will further be understood in view of the embodiment of FIGS. 9 and 10 that as used herein the word “handle” refers not only to the handle sidewalls such as 152 and 154, but also to the combination of a handle sidewall and liner as shown in FIGS. 1 through 8.

Various design modifications may be made without departing from the nature and scope of the invention described herein. As a first example, the manner in which spring pin 98 applies force against the lower side of lever 92 (in saddle 104) may be modified by forming a bore in the lever through which the spring pin extends. The size of the bore in this case would need to be slightly greater than the diameter of the spring pin in order to give the lever some “float” or room for movement relative to the spring pin 98 as the lever pivots about pin 96. This allows the lever to pivot fully about pin 96 and operate the locking mechanism.

As a second example of a variation in structure, the linear distance separating spring pin 98 and pivot pin 96 may be varied to vary the force applied to pivot lever 92. By increasing the distance between the axis through pins 96 and 98, the amount of force required to pivot lever 92 increases. Conversely, by moving the pins closer together, the force necessary to activate the lever decreases. The amount of spring force applied by spring arms 74 and 76 may likewise be varied by varying the physical characteristics of the materials used to fabricate the spring arms. For example, the relative “strength” of the spring arms may be changed by using different metals, or by changing the thickness of the material.

Finally, it will be appreciated that structure of the spring arms may be varied from the form described herein and shown in the drawing figures. As one example, the liners may be cut longitudinally from the forward end toward the rearward end to define spring arms—the rearward end of the cut is open and the forward end of the cut is closed to define the spring arms.

While the present invention has been described in terms of a preferred embodiment, it will be appreciated by one of ordinary skill that the spirit and scope of the invention is not limited to those embodiments, but extend to the various modifications and equivalents as defined in the appended claims.

I Claim:

1. A folding knife, comprising:
a handle having first and second opposed handle halves held in a spaced-apart arrangement to define a slot therebetween;
a blade having a working portion and a tang portion pivotally attached to the handle, said blade movable between a closed position and an open position and said tang portion including a notch;
a first liner between the blade and the first handle half and a second liner between the blade and the second handle half, each of said liners having an elongate slot cut therein to define first and second spring arms, said spring arm having a forward end;
a lockback lever pivotally attached between said first and second liners with a pivot pin located forward of the forward end of the spring arms, said lever having a blade engaging tooth,
a spring pin interconnecting the spring arms below said lever and rearward of said pivot pin such that said spring arms normally urge said pin against said lever to urge said lever upwardly;
whereby when said blade is in said open position said tooth on said lever engages said notch in said tang portion to lock said blade.

2. The folding knife according to claim 1 wherein said spring arms apply pressure to said lever through said spring pin at all times.

3. The folding knife according to claim 2 wherein when said blade is in the closed position said tooth applies pressure to the tang to retain said blade in said closed position.

4. The folding knife according to claim 3 wherein said lockback lever includes a saddle and the spring pin applies spring pressure to said lever in the saddle.

5. The folding knife according to claim 3 wherein said spring pin extends through a bore in said lockback lever.

6. The folding knife according to claim 5 wherein the bore through which said spring pin extends has a diameter that is greater than the diameter of the spring pin.

7. The folding knife according to claim 1 wherein said tang further includes a flattened portion generally opposite said notch, and when said blade is in the closed position said tooth is urged against said flattened portion to retain said blade in the closed position.

8. The folding knife according to claim 1 wherein said slots in said liners are generally L-shaped and extend from a closed end toward the rear end of the liners in a forward direction and extend through an upper edge of the liners.

9. In a knife having an elongate body with a forward end and a rearward end, the body formed by two opposed side walls forming a channel therebetween, and a blade pivotally attached to the body at the forward end and movable between a closed position and an open position, the improvement comprising:
a first liner member disposed between the blade and one side wall;
a second liner disposed between the blade and the other side wall;
each of said liners having a slot cut therein to define a spring arm in each liner, each of said slots extending through an upper edge of said liner to define a forward end for each spring arm;
a lever pivotally attached between said first and second liners with a pivot pin located forward of said forward ends of said spring arms, said lever having a blade engaging surface,
a spring pin interconnecting the spring arms such that said spring arms normally urge said spring pin against said lever to urge said lever;
whereby when said blade is in said open position said blade engaging surface on said lever engages said blade to lock said blade in said open position.

10. The knife according to claim 9 wherein the spring pin interconnects the spring arms rearward of the forward ends of said spring arms.

11. The knife according to claim 10 wherein the said blade includes a tang portion having a notch, and wherein said lever engages the notch when the blade is in the open position.

12. The knife according to claim 11 further including a flattened surface on said tang opposite said notch, and wherein when said blade is in the closed position said lever bears against said flattened surface to thereby retain said blade in said closed position.

13. The knife according to claim 12 wherein said blade defines a blade plane and said spring arms lie on either side of said blade plane and parallel thereto.

14. A folding knife, comprising:
a handle having first and second opposed handle halves held in a spaced-apart arrangement to define a slot therebetween;
a blade having a working portion and a tang portion pivotally attached to the handle, said blade movable between a closed position and an open position and said tang portion including a locking surface;
a lockback lever pivotally connected between said handle halves and having a forward end with a tang engaging surface;
first spring means for applying biasing force against the lockback lever rearward of the pivotal attachment between said lever and said handle halves;
second spring means for applying biasing force against the lockback lever rearward of the pivotal attachment between said lever and said handle halves;
spring pin means for interconnecting the first and second spring means rearward of said pivotal attachment between said lever and said handle halves and such that said spring pin means exerts pressure on said lever behind said pivotal attachment;
whereby when said blade is in the open position the tang engaging surface of said lever engages the locking surface of said tang to lock said blade in the open position.

15. The folding knife according to claim 14 wherein the first and second spring means further comprise slots cut in the respective first and second handle halves to define first and second spring arms having forward ends, and wherein said spring pin means interconnect said first and second spring arms near the forward ends thereof.

16. The folding knife according to claim 14 wherein said first and second spring means further comprise slots cut in the respective first and second handle halves to define first and second spring arms having forward ends, and wherein said spring pin means interconnect said first and second spring arms near the forward ends thereof.

17. The folding knife according to claim 14 wherein said tang further includes a blade retaining surface and when said blade is in the closed position the tang engaging surface of said lever is biased against said blade retaining surface to thereby retain said blade in the closed position.

18. The folding knife according to claim 17 wherein said lever includes an accurate saddle area on a lower side thereof and said spring pin means applies pressure against said spring pin means in the saddle area.

19. The folding knife according to claim 17 wherein said lever include a bore through which said spring pin means extends.

20. The folding knife according to claim 19 wherein said spring pin means comprises a cylindrical pin having a diameter and said bore has a greater diameter than said pin.
